(19) United States
(12) Patent Application Publication
(10) Pub. No.: US 2017/0373479 A1
(43) Pub. Date: Dec. 28, 2017

(54) Electrical Connector

(71) Applicants: Tyco Electronics Japan G.K., Kanagawa (JP); Toyota Jidosha Kabushiki Kaisha, Aichi-ken (JP)

(72) Inventors: Tsugumi Matsumoto, Kanagawa (JP); Ryuichi Komiyama, Kanagawa (JP); Tomoyuki Funayama, Aichi-ken (JP)

(73) Assignees: Tyco Electronics Japan G.K., Kanagawa (JP); Toyota Jidosha Kabushiki Kaisha, Aichi-ken (JP)

(21) Appl. No.: 15/631,559

(22) Filed: Jun. 23, 2017

(30) Foreign Application Priority Data
Jun. 24, 2016 (JP) 2016-125745

(51) Int. Cl. H02G 3/08; H01R 13/52; H02G 3/10; H01R 13/639

(52) U.S. Cl. CPC H02G 3/088; H01R 13/5221; H01R 13/5213; H02G 3/105; H01R 13/6395

(57) ABSTRACT

An electrical connector comprises a housing and a contact held by the housing. The housing has a hood including a receiving space for receiving a mating connector and a pair of first inner surfaces extending along a vertical direction. The first inner surfaces face the receiving space and are disposed at a first interval in a horizontal direction. Each of the first inner surfaces includes a first inclined surface extending a predetermined distance from a front end of the hood in a mating direction toward an opposite rear end of the hood.

### CROSS-REFERENCE TO RELATED APPLICATION

This application claims the benefit of the filing date under 35 U.S.C. §119(a)-(d) of Japanese Patent Application No. 2016-125745, filed on Jun. 24, 2016.

### FIELD OF THE INVENTION

The present invention relates to an electrical connector and, more particularly, to a partially waterproof electrical connector.

### BACKGROUND

In known electrical connectors used in applications in which the connector is exposed to water, the water generally falls onto an upper part of the connector in the vertical direction. The water received in the upper part spreads in a gap between a case enclosing the connector and the connector, enters the case, and reaches a side of the case. In this side, the water spreads in a gap between the case and the connector and may reach an innermost part of the case which must be protected against water for proper electrical function.

In known electrical connectors, a rubber seal ring that is separate from a housing is positioned to prevent water from entering the electrical connector. In addition to the seal ring, some known housings have an inclined surface so as to discharge water that has entered the connector. Japanese Patent Application No. 2011-150895A, for example, discloses an inclined surface formed at an inner surface of a case enclosing a connector so that water that has entered a gap between the case and the connector flows toward an opening. JP 2011-150895A discloses that a groove is formed toward the opening in the inclined surface and the capillary action due to the groove enhances the drainage performance. The inclined surface disclosed in JP 2011-150895A is provided between the case and the connector so as to discharge the water entering the connector, however, the inclined surface cannot prevent the water from entering the connector. The structure disclosed in JP 2011-150895A includes a seal ring, which allows water to enter until the water reaches the area of the seal ring.

The seal ring, although affording waterproof protection to the connector, is nonetheless an additional member required in the assembly of the connector. Accordingly, if the electrical connector is used in an application in which water penetration is unlikely, there is no need to provide a seal ring and it is sufficient to ensure a partial or light waterproof performance.

### SUMMARY

An electrical connector according to the invention comprises a housing and a contact held by the housing. The housing has a hood including a receiving space for receiving a mating connector and a pair of first inner surfaces extending along a vertical direction. The first inner surfaces face the receiving space and are disposed at a first interval in a horizontal direction. Each of the first inner surfaces includes a first inclined surface extending a predetermined distance from a front end of the hood in a mating direction toward an opposite rear end of the hood.

### BRIEF DESCRIPTION OF THE DRAWINGS

The invention will now be described by way of example with reference to the accompanying Figures, of which:

FIG. 1 is a perspective view of an electrical connector assembly according to the invention;

FIG. 2 is another perspective view of the electrical connector assembly of FIG. 1;

FIG. 3 is a sectional plan view of the electrical connector assembly taken along line III-III of FIG. 1;

FIG. 4A is a side view of the electrical connector assembly of FIG. 1;

FIG. 4B is a sectional side view of the electrical connector assembly taken along line IIb-IVb- of FIG. 1;

FIG. 5A is a sectional plan view of a portion of the electrical connector of FIG. 1;

FIG. 5B is a sectional perspective view of a portion of the electrical connector of FIG. 1;

FIG. 6A is a detail plan sectional view of a first housing of the electrical connector assembly of FIG. 1;

FIG. 6B is a detail side sectional view of the first housing;

FIG. 7A is schematic front view of the first housing;

FIG. 7B is another schematic front view of the first housing; and

FIG. 8 is a sectional view of an electrical connector according to another embodiment of the invention.

### DETAILED DESCRIPTION OF THE EMBODIMENT(S)

Embodiments of the present invention will be described hereinafter in detail with reference to the attached drawings, wherein like reference numerals refer to the like elements. The present invention may, however, be embodied in many different forms and should not be construed as being limited to the embodiments set forth herein; rather, these embodiments are provided so that the disclosure will be thorough and complete and will fully convey the concept of the invention to those skilled in the art.

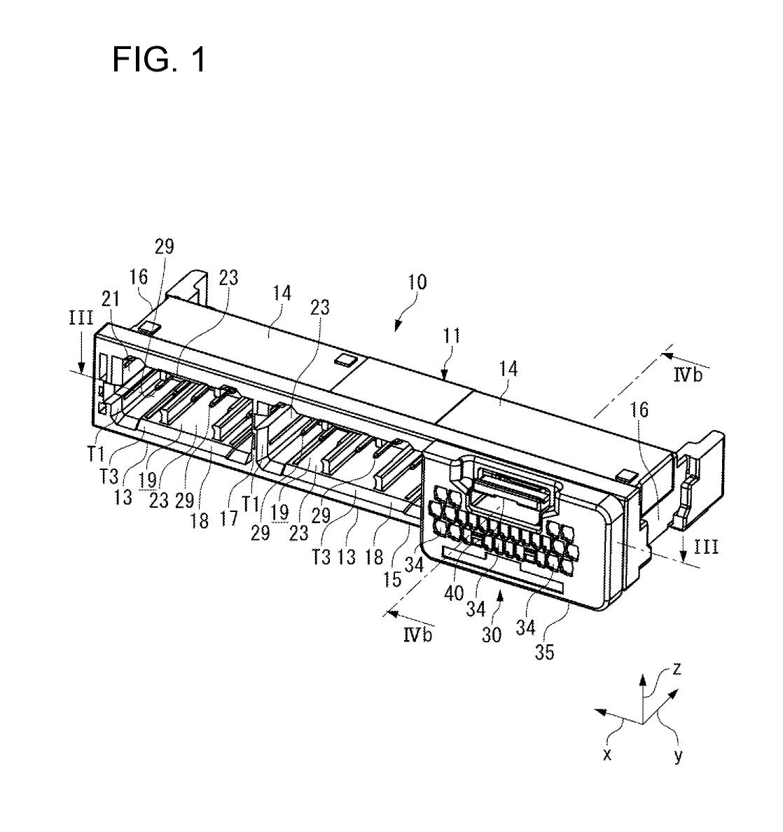

An electrical connector assembly according to the invention is shown in FIGS. 1-3. The electrical connector assembly includes an electrical connector 10 and a mating connector 30. The mating connector 30 is matable with the electrical connector 10. In the shown embodiment, the electrical connector 10 is a receptacle connector that is configured to be fixed to, for example, a printed wiring board (not shown) and the mating connector 30 is a plug connector. In the shown embodiment, the electrical connector 10 has a structure in which three mating connectors 30 are aligned and mated with the electrical connector 10; only one mating connector 30 is shown in FIGS. 1-3.

A side at which the electrical connector 10 and the mating connector 30 are mated together is defined as a front side of each connector 10, 30, and a side opposite to the front side is defined as a rear side. A side of the electrical connector assembly that is fixed to the printed wiring board and faces the printed wiring board is defined as a lower side, and a side of the electrical connector assembly that is opposite to the lower side is defined as an upper side. The major components of the invention will now be described in greater detail.

The electrical connector 10, as shown in FIGS. 1-3, includes a first housing 11 and a plurality of first contacts 29. The first housing 11 is integrally formed of an electrically insulative resin. The first contacts 29 are formed of a material having high conductivity, such as a copper-based material.

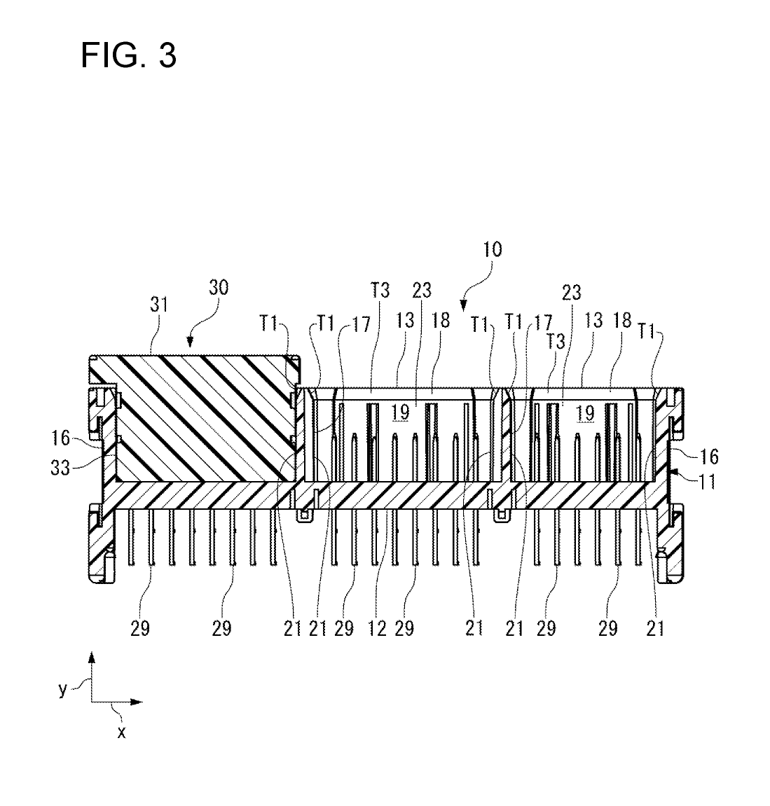

The first housing 11, as shown in FIG. 3, has a holding wall 12 holding the first contacts 29; the first contacts 29 are disposed at intervals. On one surface of the holding wall 12, a hood 13 configured to be mated to the mating connector 30 is formed. The hood 13 has a rectangular tubular shape defining an insertion opening 18 opposite the holding wall 12. The hood 13 includes a plurality of receiving spaces 19 for receiving the mating connectors 30. In the shown embodiment, the hood 13 is partitioned into three hoods 13 by partition walls 17, and the mating connectors 30 are mated with the receiving spaces 19 respectively corresponding to the three hoods 13.

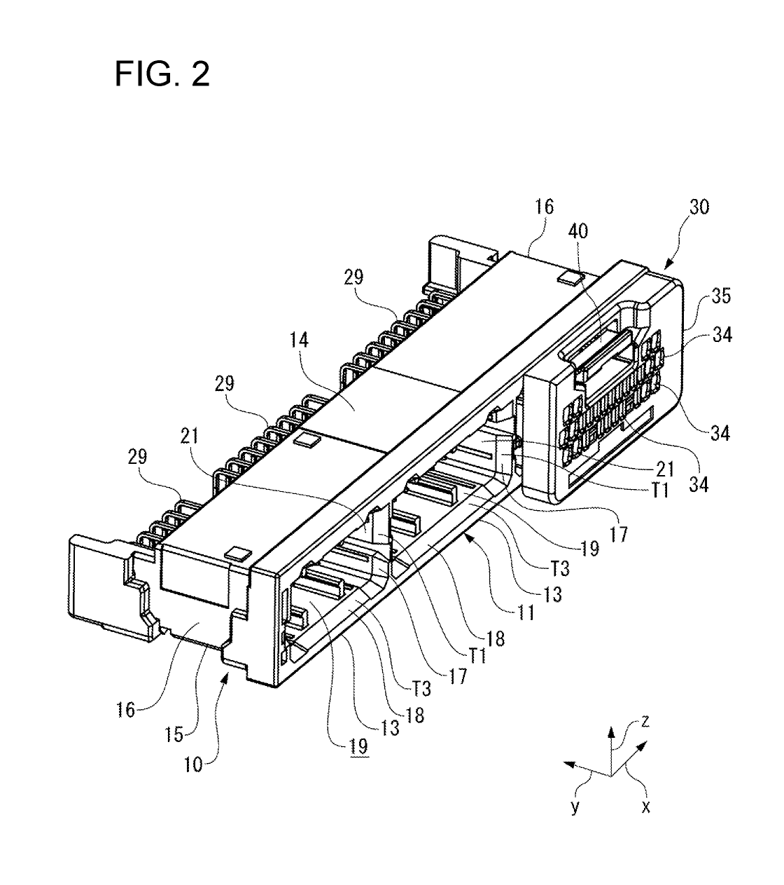

As shown in FIGS. 1-3, one part of each of the first contacts 29 that is configured to be electrically connected to a contact of the mating connector 30 extends into the corresponding receiving space 19 and another part of each of the first contacts 29 that is configured to be connected to the printed wiring board (not shown) extends rearward from the holding wall 12. The part of each of the first contacts 29 extending rearward, as shown in FIGS. 2 and 3, is bent by 90 degrees in the middle of the first contact 29. The first contacts 29 are arranged in a plurality of rows in a width direction x and are also arranged in a plurality of columns in a height direction z.

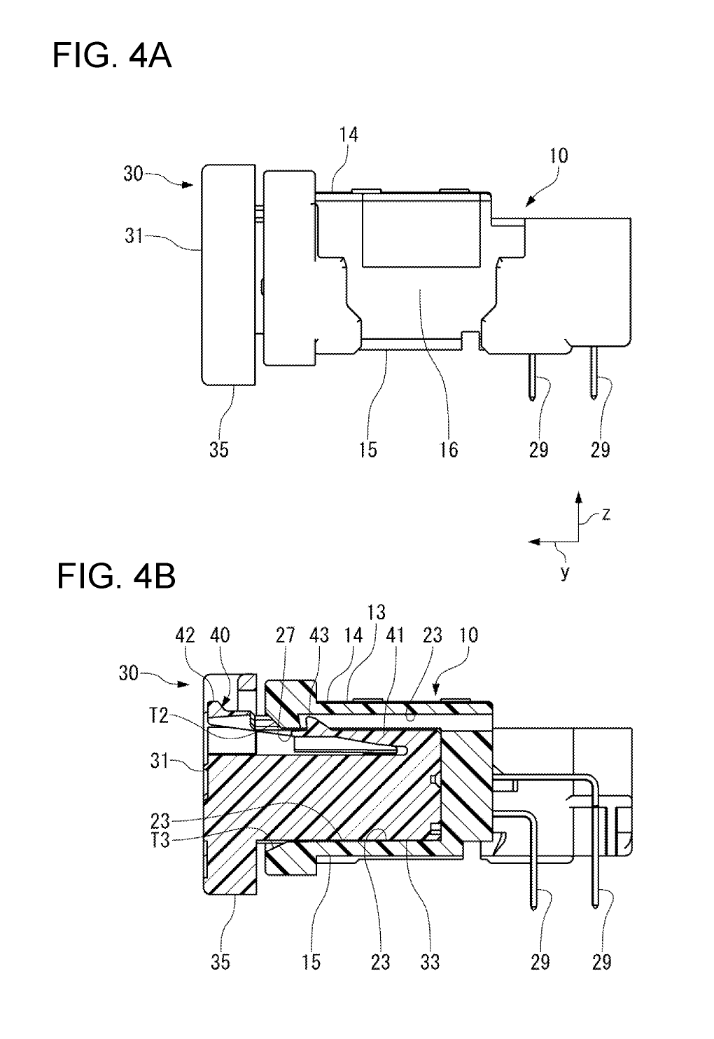

The hood 13 includes an upper wall 14, a lower wall 15, and a pair of side walls 16 as shown in FIGS. 1-3. The upper wall 14 and the lower wall 15 extend in the width direction x and are opposed to each other at a predetermined distance. The pair of side walls 16 connects both ends of each of the upper wall 14 and the lower wall 15 in the height direction z. In the hood 13, the above-mentioned partition walls 17 connect the upper wall 14 and the lower wall 15 to each other in the height direction z at positions where the hood 13 is partitioned into three hoods 13 in the width direction x. The side walls 16 and the partition walls 17 are disposed at predetermined intervals in the width direction x. A first lock projection 17, as shown in FIG. 4B, is formed on an inner surface of the hood 13.

The hood 13, as shown in FIGS. 1-3, has a first inclined surface T1 disposed at a front end of an inner surface 21 of each of the side wall 16 and the partition wall 17 facing the receiving space 19. The first inclined surface T1 is inclined from the front end toward a rear end of the hood 13 such that the thickness of each of the side wall 16 and the partition wall 17 continuously increases along the first inclined surface T1. The first inclined surface T1 extends a predetermined distance from the front end of the hood 13 toward the rear end thereof. The first inclined surface T1 is disposed along an entire length of the inner surface 21 in the height direction z or vertical direction.

As shown in FIGS. 1, 2, and 4B, the hood 13 also has second inclined surfaces T2, T3. The second inclined surfaces T2, T3 are formed at a front end of an inner surface 23 of each of the upper wall 14 and the lower wall 15 facing the receiving space 19. The second inclined surfaces T2, T3 are inclined from the front end to the rear end of the hood 13 so that the thickness of each of the upper wall 14 and the lower wall 15 continuously increases along the second inclined surfaces T2, T3. The second inclined surfaces T2, T3 extend the predetermined distance from the front end of the hood 13 toward the rear end thereof. Further, the second inclined surfaces T2, T3 are disposed along an entire length of the inner surface 23 in the width direction x so that ends of each first inclined surface T1 are connected to an end of the second inclined surfaces T2, T3.

The mating connector 30 is shown in FIGS. 1-4B. The mating connector 30 includes a second housing 31 and a plurality of second contacts (not shown) held by the second housing 31. The second housing 31 holds a number of second contacts corresponding to the number of first contacts 29, which are held by the electrical connector 10, at positions corresponding to those of the first contacts 29. The materials of the second housing 31 and the second contacts are the same as those of the first housing 11 and first contacts 29 of the first connector 10.

The second housing 31, as shown in FIGS. 1-3, includes a housing body 33 that holds the second contacts. A rear end wall 35 of the second housing 31 is continuous with a rear end of the housing body 33. A plurality of contact receiving holes 34 is formed along one direction of the housing body 33. The second contacts (not shown) are inserted into the respective contact receiving holes 34. The contact receiving holes 34 penetrate the rear end wall 35.

A lock arm 40 is disposed at a central part in the width direction on an upper surface of the housing body 33 as shown in FIGS. 1-3. The lock arm 40 is formed integrally with the housing body 33. A front end side of the lock arm 40 forms a support end 41 that is fixed to the housing body 33 and a rear end side of the lock arm 40 forms an operation end 42. The lock arm 40 includes a second lock projection 43 formed between the support end 41 and the operation end 42. The second lock projection 43 and the first lock projection 27 are locked to each other as shown in FIG. 4B, thereby preventing the mating connector 30 from being removed from the electrical connector 10, when the electrical connector 10 and the mating connector 30 are mated together.

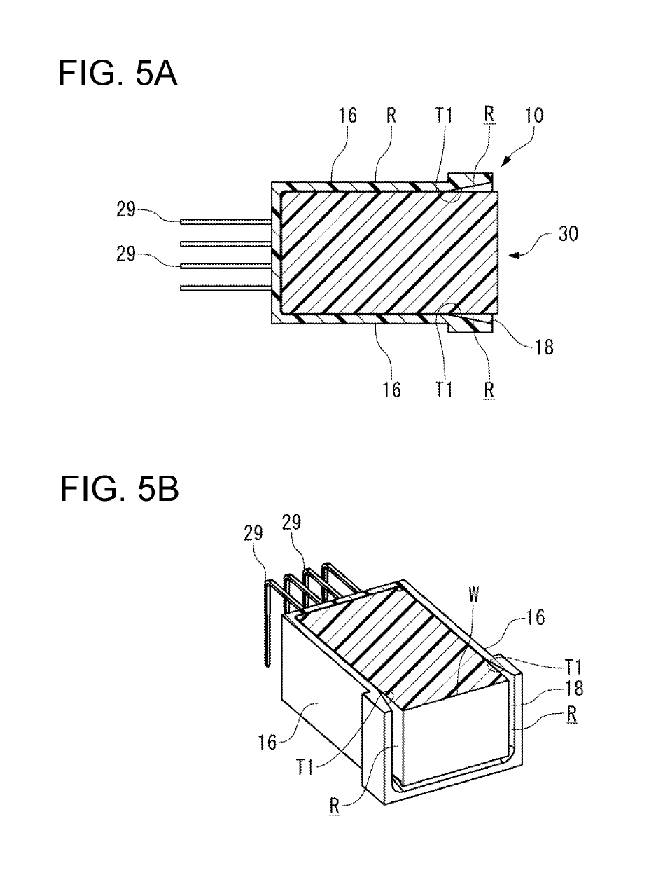

A drainage operation of the electrical connector 10 will now be described with reference to FIGS. 5A-7B.

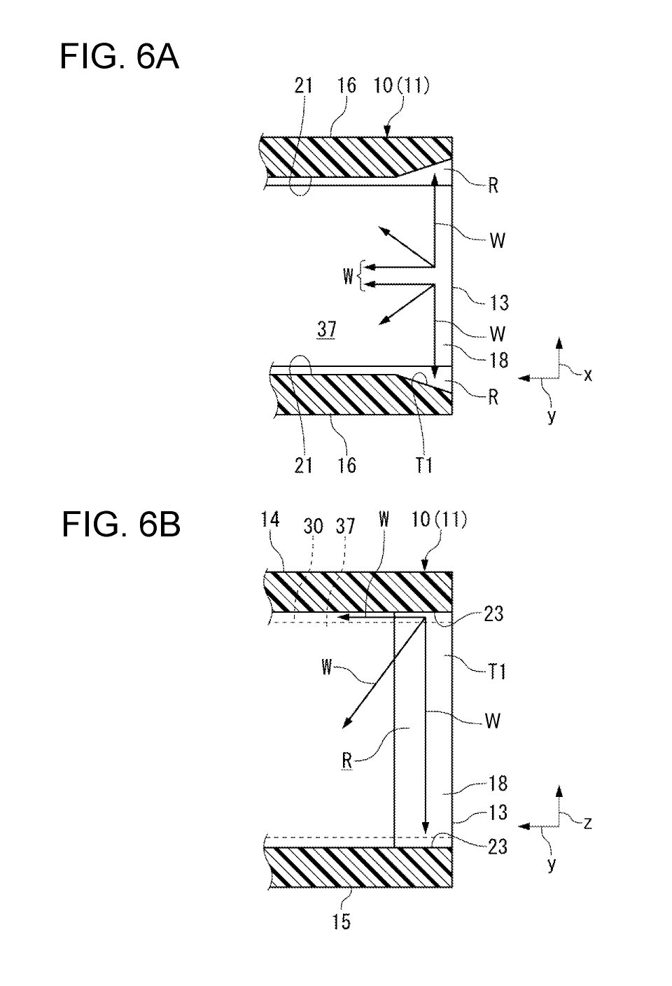

The drainage operation of the first inclined surface T1 is shown in FIGS. 5A-6B. When the electrical connector 10 and the mating connector 30 are mated together, as shown in FIGS. 5A and 5B, a gap having a triangular prism shape is formed due to the presence of the first inclined surface T1. As described below, this gap functions as a drainage path R.

A quantity of water W, shown in FIGS. 6A and 6B, falls onto the insertion opening 18 of the electrical connector 10 from above. As shown in FIG. 6B, the water W enters the gap between the inner surface 23 of the upper wall 14 of the first housing 11 and the outer surface 37 of the second housing 31 from the insertion opening 18. Since the gap between the inner surface 23 and the outer surface 37 is narrow, the water W advances in the gap between the inner surface 23 and the outer surface 37 in the width direction x and a mating direction y as shown in FIG. 6A.

The water W which has advanced in the width direction x reaches both ends where the first inclined surfaces T1 are disposed; the water W which has reached the first inclined surfaces T1, as shown in FIG. 6B, is classified broadly into water W that advances in the mating direction y toward the back of the side wall 16 and water W that advances in the vertical direction z toward the lower side of the side wall 16. However, since the first inclined surface T1 is provided on the side wall 16, a larger quantity of water W flows downward in the vertical direction along the first inclined surface T1 due to gravity rather than flowing toward the back of the side wall 16. Since the first inclined surface T1 reaches the inner surface 23 of the upper wall 14, the water W which has reached the both ends of the outer surface 37 in the width direction x largely flows toward the first inclined surface T1 rather than flowing toward the back of the side wall 16. While the side wall 16 has been described, the same holds true of the partition wall 17 provided with the first inclined surface T1. Further, since the first inclined surface T1 reaches the inner surface 23 of the lower wall 15, as shown in FIG. 6B, the water W that falls down along the inclined surface T1 may be discharged from the insertion opening 18 to the outside of the first housing 11.

In the electrical connector 10, the first inclined surface T1 is provided on each of the side wall 16 and the partition wall 17 along the vertical direction which allows the water W which has entered the insertion opening 18 between the first housing 11 and the second housing 31 to be largely guided toward the lower side in the vertical direction and discharged to the outside of the first housing 11, suppressing the flow of the water W toward the back of the hood 13.

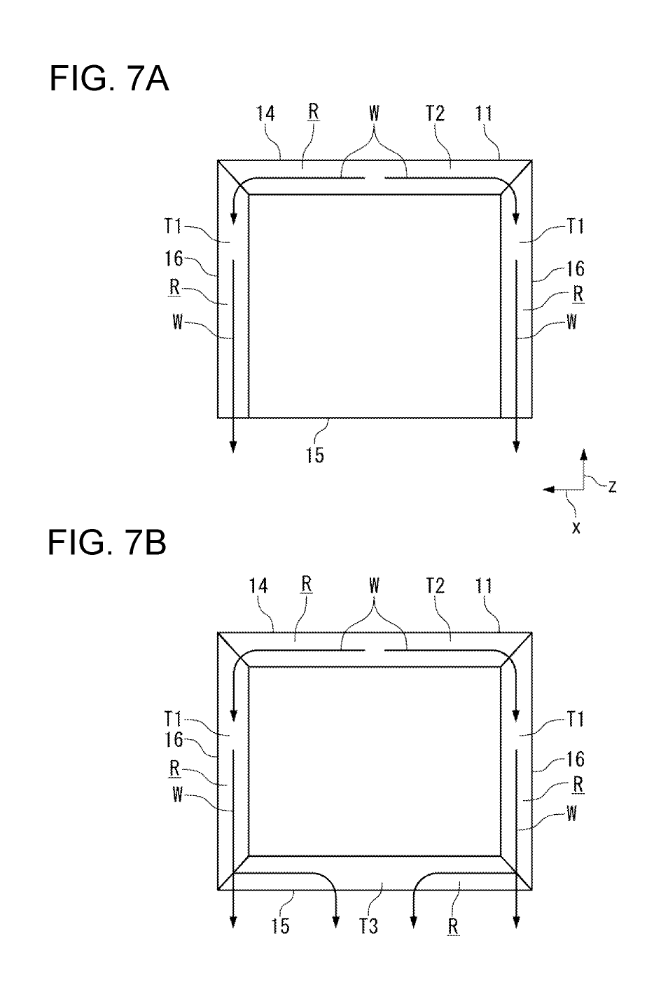

As shown in FIG. 7A, in the electrical connector 10, the upper wall 14 is also provided with the second inclined surface T2. Accordingly, on the upper wall 14, the water W flows toward both ends of the second inclined surface T2 in the width direction x, rather than flowing to the back, and reaches the first inclined surface T1 formed on the side wall 16 or the partition wall 17. The drainage path R formed by the second inclined surface T2 functions as a guide for carrying the water W toward the drainage path R formed by the first inclined surface T1.

As shown in FIG. 7B, in the electrical connector 10, the lower wall 15 is also provided with the second inclined surface T3. Accordingly, when the water W flowing to the lower end along the first inclined surface T1 reaches the second inclined surface T3 at both ends thereof in the width direction x, the water W may flow along the drainage path R formed by the second inclined surface T3 toward the center in the width direction x. Since the second inclined surface T3 is inclined downward from the back toward the front side, when the water W flows in accordance with the inclination of the second inclined surface T3, the water W is discharged from the insertion opening 18 to the outside of the first housing 11.

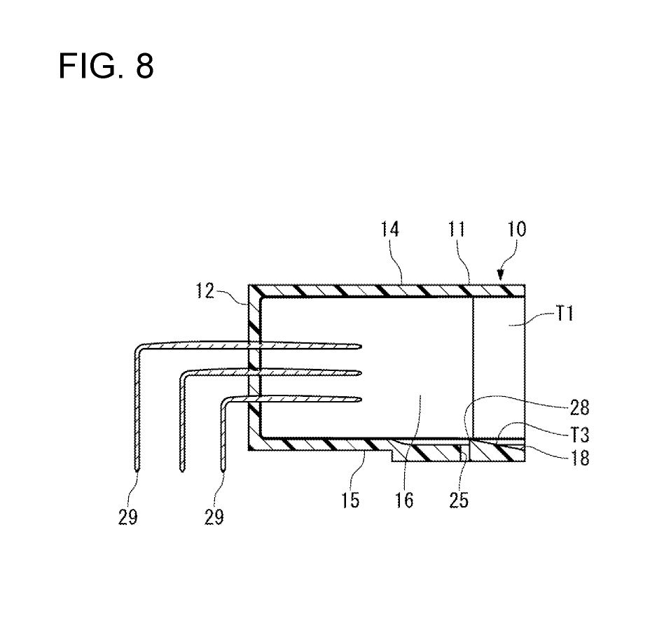

In another embodiment shown in FIG. 8, a passageway 25 is disposed extending through the lower wall 15 adjacent to a projection 28 which is located at an end of the second inclined surface T3 of the lower wall 15. The passageway 25 is disposed at the back of the hood 13 relative to the second inclined surface T3, and the water W in contact with the projection 28 that does not flow along the second inclined surface T3 flows through the passageway 25 and is discharged to the outside of the first housing 11.

In the above embodiments, the first inclined surface T1 is disposed along the entire height direction z and the second inclined surfaces T2, T3 are disposed along the entire width direction x. In other embodiments, the first inclined surface T1 may be disposed along only a portion of the height direction z and the second inclined surfaces T2, T3 may be disposed along only a portion of the width direction x. However, in these embodiments, the first inclined surface T1 extends along a length that is equal to or more than half the length in the height direction z and the second inclined surfaces T2, T3 extend along a width that is equal to or more than half the width in the width direction x.

Angles formed by the inclined surfaces T1, T2, and T3 may be determined to obtain the desired effect described above. The angles may be in a range from 5° to 25° or may be in a range from 10° to 20°. The length of each of the inclined surfaces T1, T2, and T3 from the front end of the hood 13 toward the back thereof may determine to obtain the desired effect. The length may be in a range from 3 mm to 10 mm or may be in a range from 5 to 8 mm.

What is claimed is:

1. An electrical connector, comprising:
a housing having a hood including a receiving space for receiving a mating connector and a pair of first inner surfaces extending along a vertical direction, the first inner surfaces facing the receiving space and being disposed at a first interval in a horizontal direction, each of the first inner surfaces includes a first inclined surface extending a predetermined distance from a front end of the hood in a mating direction toward an opposite rear end of the hood; and
a contact held by the housing.

2. The electrical connector of claim 1, wherein the first inclined surface is disposed along an entire length of each of the first inner surfaces in the vertical direction.

3. The electrical connector of claim 1, wherein the first inclined surface is disposed a portion less than an entire length of each of the first inner surfaces in the vertical direction.

4. The electrical connector of claim 1, wherein the hood includes a pair of second inner surfaces extending along the horizontal direction, the second inner surfaces facing the receiving space and being disposed at a second interval in the vertical direction.

5. The electrical connector of claim 4, wherein at least one of the second inner surfaces includes a second inclined surface extending the predetermined distance from the front end of the hood toward the rear end of the hood.

6. The electrical connector of claim 5, wherein the second inclined surface is disposed along a portion less than an entire length of each of the second inner surfaces in the horizontal direction.

7. The electrical connector of claim 5, wherein the second inclined surface is disposed along an entire length of each of the second inner surfaces in the horizontal direction.

8. The electrical connector of claim 7, wherein the first inclined surface is disposed along an entire length of each of the first inner surfaces in the vertical direction.

9. The electrical connector of claim 8, wherein both a first end and an opposite second end of each first inclined surface is connected to an end of one second inclined surface.

10. The electrical connector of claim 5, wherein a lower second inner surface is disposed along a lower wall of the hood.

11. The electrical connector of claim 10, wherein the hood includes a passageway extending through the lower wall.

12. The electrical connector of claim 11, wherein the passageway is disposed adjacent the second inclined surface disposed on the lower second inner surface in the mating direction toward the rear end of the hood.
